(19) United States
(12) Patent Application Publication
(10) Pub. No.: US 2004/0216568 A1
(43) Pub. Date: Nov. 4, 2004

(54) Method of destructing signals stored on compact disk

(76) Inventor: Jin-Sheng Weng, Taipei Hsien (TW)

Correspondence Address: Keith Kline, PRO-TECHTOR INTERNATIONAL SERVICES, 20775 Norada Court, Saratoga, CA, 95070-3018, US

(21) Appl. No.: 10/460,691

(22) Filed: Jun. 11, 2003

(30) Foreign Application Priority Data
Apr. 29, 2003 (TW) 92110082

(51) Int. Cl. B26D 1/00

(52) U.S. Cl. 83/13; 241/1; 241/301

(57) ABSTRACT

A method of destroying signals stored on a compact disk includes the step of destroying a Start Lead In (SLD) area on a compact disk to ruin lead-in signals recorded on the SLD, such that all other data stored on the compact disk cannot be read. Undesirable disclosure of the data stored on the compact disk is effectively prevented when the compact disk is discarded after the SLD is destroyed.

### FIELD OF THE INVENTION

The present invention relates to a method of destructing signals stored on compact disk, in which a Start Lead In (SLD) area on a compact disk for recording lead-in signals is destructed to ruin the lead-in signals, so that all other data stored on the compact disk could not be read at all, and undesirable disclosure of any data on a compact disk to be discarded could be effectively prevented.

### BACKGROUND OF THE INVENTION

In producing general compact disk (CD), video compact disk (VCD), digital videodisk (DVD) and the like, signal data to be stored thereon are converted into a series of differently sized pits and lands on the disk through specific techniques. The signal data stored on the disk in this manner are then read using a laser beam.

When a disk becomes useless and is discarded, it forms a possible gate via which important signal data stored on the disk is undesirably disclosed. To avoid such undesirable disclosure of important signal data, it is preferable to destruct such signal data before the compact disk storing them is discarded.

A compact disk in use usually has a large quantity of data stored thereon. A common way to destruct the signals on the compact disk is to completely ruin and destruct any and all data stored on the compact disk. However, since the data stored on the compact disk are distributed over considerably wide areas, it would take a lot of labor and material to have the data completely destructed. And, there is still possibility a complete destroy of data is not successfully achieved. In the event of an incomplete destroy, data stored on the compact disk may still be undesirably disclosed.

As a matter of fact, there is an area among the data storing areas on each compact disk being particularly assigned to record lead-in signals for all other data stored on the compact disk. This area is usually referred to as the Start Lead In (SLD) and located within an annular area having an overall diameter about 46 mm. That is, a radial distance between the SLD area and a center of the compact disk is about 23 mm. When the lead-in signals in this area are destructed, it would be impossible to read all other data stored on the compact disk.

Up to date, there is not any method for preventing undesirable disclosure of data stored on a useless compact disk involving in destroy of signals in the SLD of the compact disk to be discarded.

### SUMMARY OF THE INVENTION

A primary object of the present invention is to provide a method of destructing signals stored on compact disk. In the method of the present invention, lead-in signals recorded on the Start Lead In (SLD) area of a compact disk to be discarded are ruined, so that all other data stored on the compact disk could not be read and are therefore protected against undesired disclosure.

### BRIEF DESCRIPTION OF THE DRAWINGS

The structure and the technical means adopted by the present invention to achieve the above and other objects can be best understood by referring to the following detailed description of the preferred embodiment and the accompanying drawing, wherein

FIG. 1 is a sectional view of a general compact disk showing the location of the SLD area thereof.

### DETAILED DESCRIPTION OF THE PREFERRED EMBODIMENTS

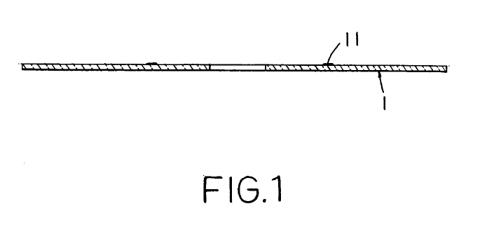

Please refer to FIG. 1 that is a sectional view of a general compact disk 1 on which a plurality of data storing areas are included. One of these data storing areas is referred to as Start Lead In (SLD) 11, on which lead-in signals for data stored on each compact disk are recorded. The SLD 11 is located within an annular area on the compact disk 1 having an overall diameter about 46 mm. That is, a radial distance between the SLD area and a center of the compact disk 1 is about 23 mm. When the lead-in signals recorded on the SLD 11 are ruined, it would be impossible to read all other data stored on the compact disk 1. Thus, the present invention provides a method of destructing the SLD 11 to effectively prevent undesirable disclosure of data stored on the compact disk 1 that is to be discarded.

In a first embodiment of the method of the present invention for destructing the SLD 11, a suitable scraping device is used to scrape off the lead-in signals on the SLD 11. In a second embodiment of the present invention, a punching device is used to punch holes on the SLD 11. In a third embodiment of the present invention, a certain type of acid liquor is used to corrode the lead-in signals on the SLD 11. In a fifth embodiment of the present invention, a particular program is used to erase the lead-in signals on the SLD 11. Once the SLD 11 is destructed in any one of the above-mentioned or other suitable ways, it would be impossible to read any and all other data stored on the compact disk 1. In this manner, the undesirable disclosure of any data on the discarded compact disk 1 can be effectively prevented. The method of the present invention for destructing data on the discarded compact disk 1 is therefore simple and convenient but complete and effective.

1-5. (Canceled)

6. A method of destroying signals stored on a compact disk, comprising:
destroying a Start Lead In (SLD) area on said compact disk to so that lead-in signals recorded on said SLD are destroyed, thereby prohibiting retrieval of all other data stored on said compact disk and eliminating the possibility of any undesirable disclosure of said other data stored on said compact disk when said compact disk is discarded.

7. The method of destructing signals on a compact disk as claimed in claim 6, wherein:
said lead-in signals on said SLD are destroyed by physically scraping material from said SLD area.

8. The method of destructing signals on a compact disk as claimed in claim 6, wherein:
said lead-in signals on said SLD are destroyed by punching a hole in said compact disk, said hole being concentric with said compact disk and having a diameter equal to said SLD.

9. The method of destructing signals on a compact disk as claimed in claim 6, wherein:
an acidic material is applied to said SLD area.
